(19) United States
(12) Patent Application Publication
(10) Pub. No.: US 2006/0146990 A1
(43) Pub. Date: Jul. 6, 2006

(54) Call logging notification apparatus, system and method

(76) Inventors: Susan Wagner, Highland Park, IL (US); Wayne H. Rothschild, Northbrook, IL (US); Shariff Alhadad, Indialantic, FL (US); Bruce A. Corbin, Indialantic, FL (US)

Correspondence Address: Bell, Boyd & Lloyd LLC, P.O. Box 1135, Chicago, IL, 60690-1135, US

(21) Appl. No.: 11/222,929

(22) Filed: Sep. 9, 2005

Related U.S. Application Data
(60) Provisional application No. 60/608,655, filed on Sep. 10, 2004.

(51) Int. Cl. H04M 1/64

(52) U.S. Cl. 379/67.1; 379/189

(57) ABSTRACT

A call logging notification apparatus including notification means to notify one or more parties to a conversation that the call is or may be recorded. The call logging notifications can include audio notifications, visual notifications, or any combination of audio and video notifications to different parties to the conversation. The apparatus includes system controls to mute or reduce the volume of an audio signal provided to a call handler. This call logging notification apparatus further provides a safeguard against a call handler accidentally or intentionally disconnecting or bypassing the notification apparatus.

### BACKGROUND

The present disclosure relates to the telecommunications industry and in particular to any telephone connection where one or more parties are to be notified that their call is being recorded (i.e., logged).

Throughout much of the history of the telephone there have been laws to protect the privacy of the persons participating in the call. One aspect of current legislation is the requirement for consent to be obtained from one or more of the parties to a call to have the call recorded, referred to as call monitoring, call logging or simply logging. The exact form of this consent is governed by Federal Law and State Laws and regulations that may vary from state to state. Certain laws permit recording of phone calls and other electronic communications with the consent of at least one party to the call. Others require the consent of all parties to a conversation.

Two notification methods currently used to meet these requirements (i.e., effectively obtain consent for recording) are an audible tone generated at specified intervals for the duration of a call, and/or a verbal announcement at the initiation of the call that the call will be or may be recorded.

There currently exist in the telecommunications marketplace logging and other equipment that have the ability to provide verbal or tone notification in certain circumstances. For example, many facilities utilize canned messages generated by an Interactive Voice Response (IVR) or Automatic Call Distributor (ACD) announcing to incoming callers that a call may be recorded. This occurs prior to the call being connected to a live call handler or operator. Therefore, utilizing such announcements from an IVR or ACD at the receipt of the call, prior to the actual logging, has the disadvantage that this notification to the caller is not present on the logged conversation files, as the notification was issued prior to the actual recording. This creates the potential to give rise to claims by calling parties that they did not hear the announcement. This could actually be the case if, for instance, a caller was distracted from the phone when the announcement played, or, in impatience, bypassed the announcement by immediately pressing “0” on their telephone keypad, which is oftentimes how a caller can initiate transfer to a call handler without having to listen to the IVR/ACD menu options.

Other stand-alone logging systems may simultaneously be able to generate a “beep tone” while recording.

Oftentimes logging systems are employed that do not have the capability to generate such announcements or notifications. For example, a call/contact center facility may have limited or no IVR/ACD announcement capabilities for inbound calls. In addition, many sophisticated server-based logging systems can only passively record the call and cannot, due to switch resource or other technical or economic limitations, inject the necessary audio or beep tone into the audio path between the facility and one or more parties to the call. Further, frequently when a call that is initiated at a facility is being recorded (an outbound call), providing the required notification at the beginning of the call can become technically difficult.

Currently available auxiliary call logging notification devices (those that do not record phone conversations but merely generate beep tones or announcements/requests for consent) in the telecommunications marketplace are generally add-on devices that are installed between the handset and the telephone or computer. An example of such a device is the TBR-10 manufactured by DynaMetric. A disadvantage of the current devices is that a call handler could potentially disconnect and bypass the equipment, intentionally or otherwise, and still be able to handle calls, thereby leaving the call center facility at risk for non-conformance to its legal requirements for obtaining consent for recording/logging.

Another disadvantage of the current devices is that a call handler may intentionally want to disconnect a currently installed tone generation device because it lacks the ability to selectively generate audible tones to only one party (i.e., to person(s) on the call other than the call handler). Because the call handler is constantly exposed to these recurring tones for the duration of an entire work shift, it creates a source of environmental stress at the workplace for the call handler, who cannot stop from hearing the tone whenever he/she is on the phone. The inability to generate tones audible only to the other parties to the call (thereby relieving the call handler from having to listen to the tones for the entirety of a shift) points to a deficiency in these devices that may further induce a call handler to not report when his/her call logging notification device is not working. Furthermore, alternative methodologies for alerting the facility that such a device is not operating are not currently available.

Another disadvantage with the current technology, specifically for auxiliary devices that generate verbal announcements, is the reliance of automatic operation of the device to identify accurately the on the on-hook vs. off-hook condition of the phone set. For inbound calls, where the parties to the call are connected by virtue of the call handler picking up the handset (placing the phone “off-hook”), this may be adequate to the needs of the facility. However, for outbound calls, the phone goes off-hook when the call is initiated, which is prior to all parties being connected causing a premature announcement of the recording. The facility is therefore reliant on the call handler remembering to manually trigger the verbal announcement once all parties are on the line (i.e., when the called party/(ies) pick up the phone). Failure of the call handler to manually trigger the verbal notification of logging on outbound calls is an example of unintentional non-compliance that could potentially expose the call handling facility to legal liability. Furthermore, it must be noted that call logging notification does not require that the call actually be recorded. In fact, many notification messages indicate that the call may be recorded. This can be sufficient to comply with the law.

Furthermore, with the advent of video phones and computer based audio/video communications, the audio notification announcement or beep can be replaced, substituted, or supplemented with a visual notification on the display screen.

Though these examples are not exhaustive, what is clear is that new methods and devices are needed to assure that a call handling facility will consistently meet the call logging notification requirements in situations where the logging equipment employed at the facility has satisfactory recording capabilities but lacks the ability to comply with the laws and regulations governing one or multi-party notification of logging. Also required is a reduction in the environmental stress on the call handler and the ability to control when and how the logging notification is provided. Further required is a system that assures that the call logging notification will be captured in the actual recording of the call.

### SUMMARY

The present disclosure relates to systems and methods, individually and/or collectively, that operate in a call center facility and enable the delivery of call logging notification verbally and/or by using beep tones and/or by visual indication to one or more parties to a call to indicate that the call is being or may be recorded.

As herein described the present disclosure provides audio and/or visual call logging notification to one or more parties to a telephone or videophone conversation. The present disclosure functions independently, and in some cases includes the ability for the device to process call information or other data and provide the appropriate logging notification. Additionally, the present disclosure can function in collaboration with a similarly independent call logging system whereby the logging system can send signals which are processed by the disclosed notification system such that the appropriate call logging notifications are produced.

In its various embodiments, the one or more parties are notified by audio and/or visual signals produced by software, firmware or circuitry that can be attached to or embedded into the equipment traditionally found in the telephone call center and are required to enable calls to be handled/processed. This equipment may include but is not limited to the telephone deskset, head set, amplifiers, cords, punch down stations, telecommunication switches, telephony PC workstations, call logging devices, etc. It is applicable for corded, cordless and wireless solutions. In an embodiment, parties are notified of call logging regardless of whether or not call logging is actually occurring.

Further, the present disclosure relates to a system that provides call logging notification that is installed in a manner or location that precludes the ability and inclination of individual call handlers to disconnect or otherwise bypass the call logging notification. This may include embedded circuitry, a network server connected to a PBX, or other telephone switch or voice portal.

Additionally, the present disclosure relates to system controls operative to mute (or reduce the volume) in the operator's earphone of perpetual beep tones or announcements, thereby reducing environmental stress on the call handler while still providing the required call logging notification (i.e., the path to the customer will not be muted and therefore the called or calling party will continue to receive the required notification). Further, in an alternate embodiment, the customer continues to receive the required notification while at the same time, the call handler is notified that the call logging notification beep tones are being injected into the conversation without actually having to hear the beep tones. Such a notification can be indicated to the call handler via an audio, verbal, visual or audiovisual indication.

Specifically, the present disclosure relates to a system comprised of one or more components including circuitry, hardware, firmware and/or software that provide call logging notification via announcements, beeps or visual indication and is integrated into equipment typically existing at the call center, and that is required to be utilized in order for a call handler to complete the purpose of the call (i.e., handle calls). Such equipment already required at the call center includes, but is not limited to: headsets or handsets that the operator must use in order to hear and be heard; external or internal amplifiers that reside in between the headset/handset and the telephone or computer that are required for the same purpose; headsets and base stations for wireless headset configurations; telephone desksets; computers; CRTs, LCDs, LEDs and other visual displays; and others components that will be addressed herein.

For example, detection circuits can be used to detect a lack of call logging notification audio.

In addition, indicators that provide a visual and/or audio alert to the lack of detected call notification audio can be used as well. These indicators could be included in the same assembly that provides the call logging notification audio or the indicators could be remotely located. These indicators may be audio or visual and may consist of beep tones, LEDs, illuminated devices, text displays, CRTs, LCD and/or any other display device. The indicators may be always on, server controlled, locally controlled, remote controlled, or activated by the caller handler's active or passive election to have the in-phone audio warning muted. The indicators may include a communications medium input/output for communicating bidirectionally with other devices. Further, the indicators may be activated through control signals sent via the communication input/output, or provide control or other signals to other devices.

It should be appreciated that indication of call logging notification can be provided in differing manners to different parties to the conversation. For example, the indicator at a call center deskset may be a visual one while the indicator to the other parties to the conversation may be an audible one. In an alternate embodiment, the call logging notification can be embedded within a call logging device, wherein the call logging device provides call logging notification to the parties of a conversation. In addition, the call logging device with embedded call logging notification is configured to provide call logging notification in different manners to the different parties to a conversation. For example, the call logging device with embedded call logging notification capabilities may provide audio notification to one party to a conversation via a beep or tone, and may provide visual notification to another party to the same conversation via a text message or illumination of an indicator.

Further, the system can include indicators that provide an indication that the call logging notification audio has been muted to the operator's earphone. These indicators could be included in the same assembly that provides the call logging notification audio or the indicators could be remotely located. The system can also include a data port included in the call logging notification device operative to receive and/or transmit control messages and/or other signals.

The present disclosure also relates to control methods and mechanisms (within the circuitry, unidirectional to the circuitry from an outside source or bidirectional between the circuitry and an outside source) for the circuitry that include but are not limited to hardware, software, voice activation and voice recognition, such methods including: enabling/disabling commands to the embedded device; triggering of the notification announcement or beep tones; delivering other call event messages to the embedded device; and automatically notifying the call center when logging notification is failing. Such control methods can be realized in one embodiment by the communication of control or other signals between the various devices utilized by a call center facility.

Such control functionality can also be performed by state machines and logical building blocks in an Application Specific Integrated Circuit (ASIC), Field Programmable Gate-Array (FPGA) or similar technology solution that blurs the distinction between a hardware solution and a software solution.

The benefits of the present disclosure derive from overcoming the limitations and disadvantages inherent in currently existing ancillary, embedded, and non-embedded call logging notification devices, and provide the following: a reliable and insurmountable call logging notification system that a call handler cannot easily deactivate or otherwise circumvent and remain able to perform his/her task of handling calls; the ability of the call center facility to control, either centrally through a network or at individual operator workstations, the generation of beep tones, verbal and/or visual logging notification announcements; the ability to alert the call center facility to failures in call logging notification; the ability to de-activate the transmission of beep tones and/or verbal announcements to the call handler's headset or handset for the duration of the call, where legally permissible, thereby reducing environmental stress to the call handler; the ability to augment or substitute visual notification when the call handler actively or passively has their audio notification muted; reduced clutter at the operator's workstation, as additional modules, and additional power cords and outlets are not required to facilitate the call logging notification; the ability of a call center facility to easily convert from one logging system to another easily and economically, as replacing the call logging notification equipment will not be required; other economic benefits, including the relative minor incremental cost to embed the circuitry and methods into equipment the call center facility is already purchasing in order to perform its service of handling calls versus the cost of purchasing add-on and/or standalone ancillary equipment/systems; the elimination of the need to add an auxiliary device to a telephone system or workstation, which can result in lack of technical compatibility and other unanticipated complications that can arise when disparate pieces of equipment from different manufacturers are placed together; and the ability to display visual call logging notification to one or more parties when the call is conducted over a video phone or a PC based audio/video communication.

Although numerous embodiments are described in the specification, countless alternate embodiments are possible and fall within the scope of the present disclosure. Additional features and advantages of the present disclosure are described herein, and will be apparent from, the following Detailed Description and the Figures.

### BRIEF DESCRIPTION OF THE FIGURES

FIG. 1 illustrates an example of headset/handset amplifier in accordance with the present disclosure.

FIG. 2 illustrates an example of an analog headset/handset amplifier with embedded call logging notification.

FIG. 3 illustrates an example of a headset/handset amplifier with embedded call logging notification and analog/digital conversion capabilities.

FIG. 4 illustrates an example of a flowchart related to a notification device that constantly beeps.

FIG. 5 illustrates an example of a flowchart related to receiving control information.

FIG. 6 illustrates an example of a flowchart related to the injection of call logging notification audio.

FIG. 7 illustrates an example of an electrical schematic overview utilizing “RC Timer” technology.

FIG. 8 illustrates an example of an electrical schematic overview utilizing a microcontroller and series injection of call logging notification.

FIG. 9 illustrates an example of an electrical schematic overview utilizing a CPU, computer components and parallel injection of call logging notification.

FIG. 10 illustrates an example of a handset with embedded call logging notification capabilities.

FIG. 11 illustrates an example of a headset with embedded call logging notification capabilities.

FIG. 12 illustrates an example of a beep/verbal notification device incorporated into a Bluetooth receiver.

FIG. 13 illustrates an example of a beep/verbal notification device incorporated into a Bluetooth transponder.

FIG. 14 illustrates an example of a telephone deskset with embedded call logging notification capabilities.

FIG. 15 illustrates an example of a punch-down block connecting workstation cables to a PBX.

FIG. 16 illustrates an example of a beep/verbal notification device installed at the punch-down-block level.

FIG. 17 illustrates an example of a beep/verbal notification implementation utilizing requires conferencing ports.

FIG. 18 illustrates an example of a telephone deskset with a light to provide visual call logging notification.

FIG. 19 illustrates an example of a telephone deskset with a text display that provides visual call logging notification.

FIG. 20 illustrates an example of a telephone amplifier with a light to provide visual call logging notification.

FIG. 21 illustrates an example of a telephone amplifier with a text display that provides visual call logging notification.

FIG. 22 illustrates an example of a video phone with visual call logging notification.

FIG. 23 illustrates an example of a computer telephony system with visual call logging notification.

FIG. 24 illustrates an example of a visual call logging notification device installed between the deskset and the wall plug.

FIG. 25 illustrates an example of a visual call logging notification device installed between the deskset and the handset.

### DETAILED DESCRIPTION

While the present disclosure is susceptible of embodiment in various forms, there is shown in the drawings and will hereinafter be described a preferred embodiment of the invention with the understanding that the present disclosure is to be considered as setting forth exemplifications of the invention which are not intended to limit the invention to the specific embodiment illustrated.

The present disclosure includes systems, methods and apparatus to provide verbal, audio and/or visual notification of call logging to some or all parties to a telephone call. Each and all notified parties are individually notified using any or all of the verbal, audio and/visual notification methods. In some embodiments, the call logging notification device acts independently or under telephone off hook situations. In other embodiments the call logging notification device acts in response to signals generated by external call handling equipment. The device herein described performs notification and/or processing functions, but does not provide actual call logging. However, in an alternate embodiment, such a device could be incorporated into devices that provide call logging.

The present disclosure performs in a manner in which calls may or may not be logged while call logging notification is provided. In addition, in an alternate embodiment, call logging notification is indicated in different manners to the different parties to a conversation. Furthermore, call logging notification may be indicated to some or all parties to the conversation. In addition, in another embodiment, signals can be communicated to and from the device such that the generation of beep tones, verbal and/or visual logging notification announcements, the ability to alert the call center facility to failures in call logging notification, and the ability to de-activate the transmission of beep tones and/or verbal announcements to the call handler's headset or handset for the duration of the call, for example, can be controlled remotely.

Amplifier with Call Logging Notification

Many call handling stations utilize a device referred to as a headset (or possibly headset and/or handset) amplifier. These devices perform some sort of a necessary and/or desired function(s) on the signals between the headset/handset and workstation/deskset. Commonly this function is amplifying the signals from the headset and/or handset microphone. In addition, the amplifier device could include one or more of the following functionalities: control affecting the volume of the customer's voice in the operator's ear; a mute switch for muting the path from the operator's microphone to the customer's earphone; a power indicator (LED or other indicator); a mute status indicator (LED or other indicator); an Automatic Level Control (ALC) and/or Automatic Gain Control (AGC) circuit; a switch for handset or headset selection; and filtering or other signal processing capability to improve communications quality.

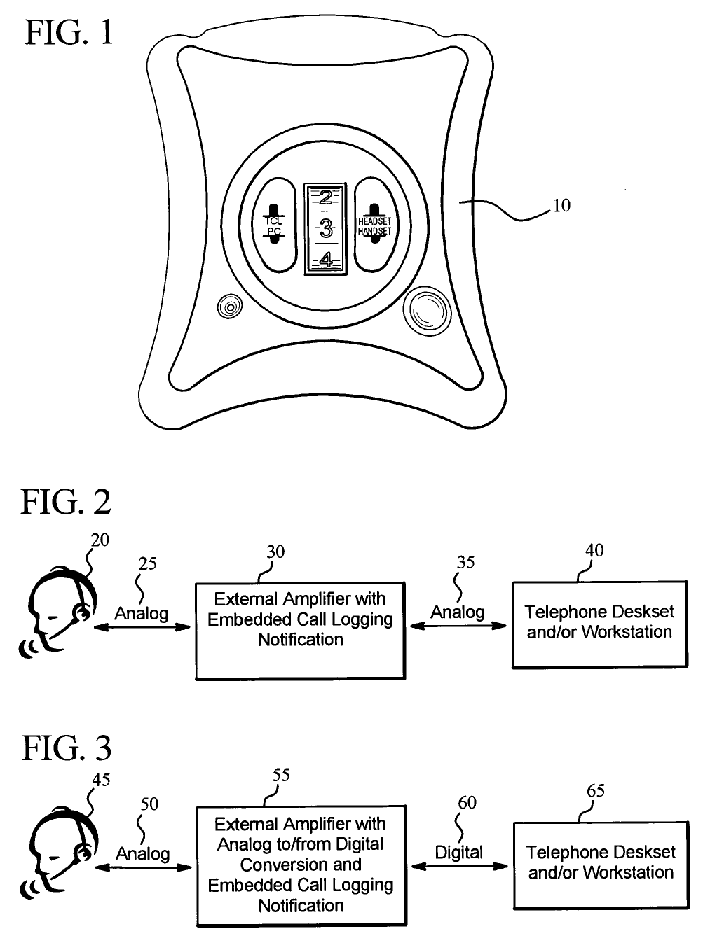

Referring to FIG. 1, according to an embodiment of the present disclosure the call logging notification functionality is embedded in a headset/handset amplifier (10) for use at the workstation.

FIG. 2 illustrates an example of such an amplifier (30) where the amplifier's audio is in an analog format for both the headset (20) and the workstation and/or deskset (40), or other equipment. In this illustration, the input and output of the amplifier's audio is in an analog format at both the headset connector (25) and the connector for the workstation (35), deskset or other telephone equipment. Amplifiers with analog inputs and outputs have been in the telecommunications marketplace for many years. An example of such an amplifier includes the M12 amplifier manufactured by Plantronics. In a further embodiment, a visual indicator is included to provide visual call logging notification to the call handler and/or other parties to the call which may include a text or image display.

FIGS. 2 and 3 generally illustrate common equipment configurations used for systems where the call logging notification circuitry resides in an external headset amplifier. In this configuration, the call cannot be handled by the call handler without the external amplifier being present and operational. That is, the headset would not work properly if connected directly to the telephone without the amplifier between the two, and therefore, the call handler could not do his/her job of handling the call.

FIG. 3 is similar to FIG. 2 except that the external amplifier (55) has the capability to perform conversions between analog (50) and digital (60) formats. Amplifiers with conversion between analog and digital formats are much newer to the telecommunications marketplace and currently would include those that utilize the Universal Serial Bus (USB) digital format and Voice Over Internet Protocol (VoIP) digital format. An example of such an amplifier includes the DA60 USB amplifier manufactured by Plantronics.

Referring to both FIGS. 2 and 3, the amplifier (30, 55) connects the headset (20, 45) to either or both the telephone deskset and workstation (40, 65). This workstation can be based upon common “personal computer” hardware, other industry standard hardware, or the workstation can be a proprietary hardware platform. The workstation can utilize peripheral cards specifically designed for the telecommunications industry or it can utilize standard audio cards for the headset interface and standard network cards for the network interface.

Although in the preferred embodiment the amplifier is connected to the telephone deskset in a conventional manner, it may be connected to the workstation in many potential ways. An example includes a customary audio connection to the workstation that is standard on multimedia amplifiers. Another example includes a data connection which can be utilized for control commands to be transmitted between the amplifier and control software from or via the call handler's workstation. It should be appreciated that numerous alternative embodiments are possible for connecting the amplifier to the workstation.

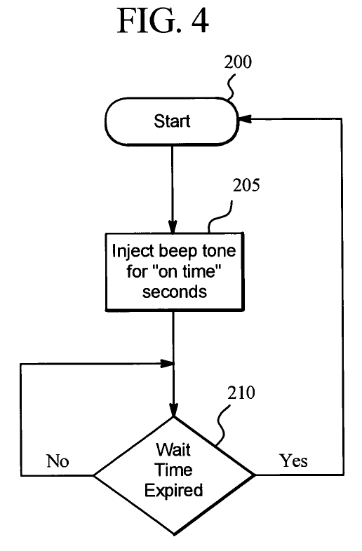

Referring to FIG. 4, FIG. 4 illustrates an example flowchart for a call logging notification device that provides a constant audio indicator for notification purposes. After beginning at step 200, a call logging notification device injects an appropriate beep tone at step 205 an appropriate time interval for the entire duration of time that the device is active. Alternatively, the device can be configured to beep only when the phone is off hook. At step 210, a determination is made as to whether the particular device has waited the appropriate time interval. If it is determined at step 210 that the notification device has waited the appropriate time interval, the process repeats and the beep tone is injected appropriately. If, however, at step 210 it is determined that the notification device has not waited the appropriate time interval, the process repeats the determination step 210, until the determination is made that the device has waited the appropriate time interval. As stated above, once the determination is made that the device has waited the appropriate time interval, the process then repeats beginning at step 200.

The overall software functionality is typically segregated into discrete functional tasks. These segregated tasks are typically analyzed and programmed individually even though they are related to and dependent upon each other. The task of receiving control information is segregated from the task of acting upon the control information.

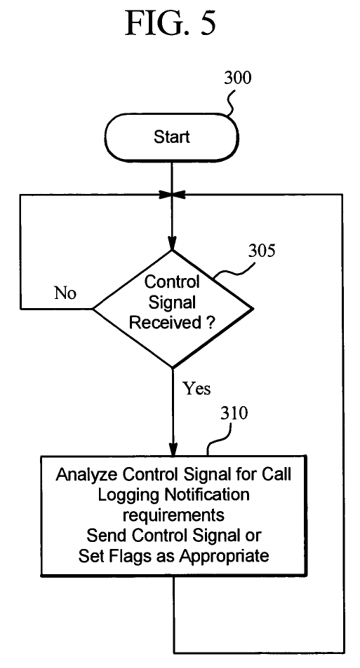

Referring now to FIG. 5, FIG. 5 illustrates an example flowchart of how a notification device receives control information. The software flow chart of FIG. 5 details, at a high level, the control information receiving tasks that are performed by software. Alternatively, this functionality can be performed by state machines and logical building blocks in an ASIC or FPGA implementation that blurs the distinction between a hardware solution and a software solution. It should be appreciated that numerous alternative embodiments are possible and that the examples are meant to be illustrative and not exclusive.

The flowchart begins at step 300, and advances to step 305, wherein a determination is made as to whether “control signals have been received.” The implementation of determination step 305 can be expanded or eliminated depending on the system being used. It must be noted that control signals may be: a) received and/or sent wholly within the call logging notification system; and/or b) received from devices and/or systems outside the invented system, for example, from other software on the workstation, a PBX, predictive dialer or ACD, or from an independent call logging system that needs to send call information to the call logging notification system. If this code is only executed after a hardware receiver chip asserts an “interrupt” indicating that data has been received then the inclusion of step 305 is not necessary. However, if the flowchart of FIG. 5 is executed upon reception of any type of received signal, then the “control signals received” may need to be analyzed to segregate control signals from other types of messages at step 310. In either case, the method only advances from step 305 to 310 if control signals have been received.

At step 310 the control signals are then analyzed. If the control signals comprise a “play notification audio” message, then the analysis is less complicated as it only requires interpretation of a limited amount of data. If the control signal is a message containing a single or a composite of low level call progression elements, then the analysis becomes more involved, as the analysis of the data may need to be “stateful” and construct a logical conclusion as to the current state of the call based upon fundamental call progression elements such as on-hook, off-hook, dial tone present, dialing, detection of answer, detection of voice, etc. Even more creative solutions are utilized to analyze the control signals when the control signals additionally contain information for and from other workstations or other types of information such as digital audio data.

The statement “set flags as appropriate” indicates that the conclusion of the analysis at step 310 needs to be stored in some manner. In one embodiment, information such as the call is or is not in progress, needs to be stored by a “data received interrupt service routine.” In an alternate embodiment, various fundamental call progression informational elements need to be stored for later use by the interrupt service routine when it is again executed after receiving additional fundamental call progression informational elements. In a further embodiment, the various informational elements may be stored external to the notification device, wherein the device provides the information to the external storage via signals communicated from the device. After flags have been sent appropriately at step 310, the flowchart returns to step 305 wherein the process repeats.

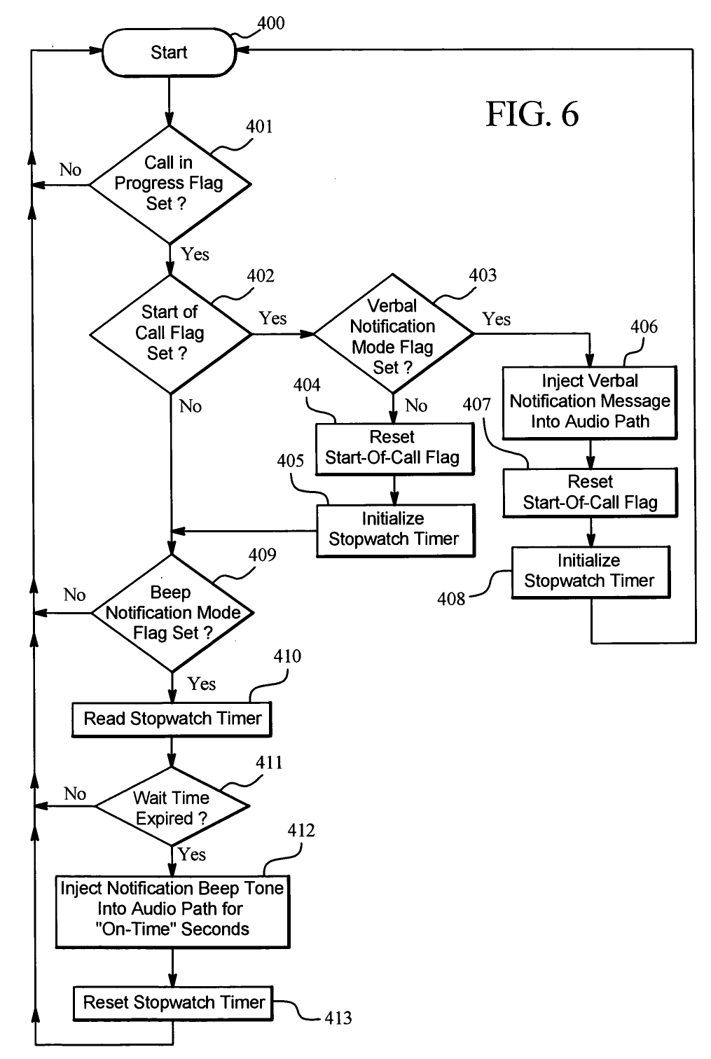

Turning to FIG. 6, FIG. 6 illustrates one of many possible embodiments of a flowchart related to the injecting of an audio call logging notification into a conversation, and will be referred to as the “main code.” The main code” is executed almost constantly, the only exception being when something, typically an external hardware signal, causes the “main code” to be interrupted. Such an “exception” or “interruption” was described above with reference to FIG. 5. As such, the flow change shown in FIG. 5 will be referred to as an interrupt service routine or an exception processing routine since it is executed when an interrupt causes an exception to the “main code” being executed.

Once again, the functionality detailed in FIG. 6 can be implemented in a hardware, software or in an ASIC, FPGA or similar technology implementation, that blurs the distinction between hardware and software. As stated previously, in an embodiment, the control mechanism may reside outside the amplifier and be configured to receive call progress and logging information and/or notification requirements from a system independent of the call logging notification system. Such systems include but are not limited to, a PBX, ACD, IVR, predictive dialer, server or other system, including an independent call logging system.

FIG. 6 also illustrates the logical flowchart for a control mechanism which may be resident inside and/or outside of the amplifier or other call logging notification device as described.

In the embodiment where the analysis is performed outside of the device, the settings of flags shown in FIG. 5 may be replaced with the transmission of signals which cause the notification device to generate the appropriate notifications. The control signals can be of the straightforward “play notification message” type or they can be a more complex set of fundamental call progression informational elements. The exact details of the initialization task is implementation dependent and therefore will vary depending upon the embodiment utilized.

In one possible embodiment, receiver and transmitter chips are utilized for the flow of control information. Such chips can comprise individual hardware chips or functional blocks added to the processor or microcontroller. These chips or functional blocks, if used, may require initialization in the form of a reset pulse, a loading of control registers, or other reset sequence activity. Alternatively, the control can be accomplished by a relay closure, switch press, voltage assertion or some other method that might be simplistic enough to not require initialization. Once again, the widespread use of ASICs and FPGAs makes it possible for the control path to be implemented in a manner that blurs the distinction between hardware and software.

Before describing FIG. 6 in detail, FIG. 6 requires a discussion concerning the flags and the stopwatch timer. The term flag generally relates to some sort of a memory location or locations that store information. It is common for a flag to represent a “yes” or “no” state, and that is the case for the flag referred to in the present disclosure. The “verbal notification mode” and “beep notification mode” flags of FIG. 6 are used to turn on or off verbal and beep forms of audio notification. FIG. 6 utilizes these two flags in a manner that allows both to be off, one to be on and the other off or both to be on. The proper utilization of these flags and their controlling signals are dependent upon the laws and regulations governing the call being logged.

Referring to the third type of flag referenced in FIG. 6, the “start of call” flag, set in this example by the interrupt service routine as described above in FIG. 5, signifies that the “customer” is on the line. Additionally, if the call is governed by “two party” laws, then the “start of call” in FIG. 6 indicates that all parties requiring notification are present on the call. As a point of contrast, the “start of call” flag in FIG. 6 would not be asserted true during the time period where the call handler's phone line is engaged but the customer's phone is still ringing.

Lastly, referring to the stopwatch timer, the stopwatch timer in FIG. 6 represents some form (hardware, software, ASIC, FPGA, etc.) that allows the software to be aware of the elapsed time since the last assertion of an audio notification tone. Note that throughout the middle of a call with beep mode activated there would be a repetitive cycle of asserting a beep tone and resetting the stopwatch timer to “zero time since the last beep.” The portions of the flowchart of FIG. 6 that are processed after the “start of call” flag is set, contain blocks indicating that the stopwatch timer is “initialized” (405, 408). These “initialization” blocks (405, 408) reset the stopwatch timer resulting in a full “wait time” elapsing before the first audio beep is asserted. Alternatively, the stopwatch timer can be initialized to a non-zero value at the beginning of a call resulting in less elapsed time before the first beep is asserted. The embodiment of FIG. 6 supports asserting the first beep sooner, and therefore, provides functionality that may be required for compliance with laws governing call logging notification.

Turning now to the description of FIG. 6, FIG. 6 illustrates an example of a method for injecting audio call logging notification into a conversation. FIG. 6 begins at step 400, and progresses to step 401, wherein a determination is made as to whether a call in progress flag has been set. If the call in progress flag has not been set, the method repeats to step 400. If the call in progress flag has been set, the method advances to step 402, wherein a determination as to whether a start of call flag has been set. If the start of call flag has not been set, the method advances to step 409, which will be further explained herein. If the start of call flag has been set, the method advances to step 403, wherein a determination is made as to whether a verbal notification mode flag has been set. If the verbal notification mode flag has not been set, the method advances to step 404 wherein the start of call flag is reset, advances to step 405 wherein a stopwatch timer is initialized, and advances to step 409, which will be further explained herein.

If, however, at step 403 it is determined that the verbal notification mode flag has been set, the method advances to steps 406, wherein a verbal notification messages is injected into the audio path of the call, while at step 407 the start of call flag is reset. The method then advances to step 408 wherein the stopwatch timer is initialized, before returning to step 400.

Referring to step 409, a determination is made at step 409 as to whether the beep notification mode flag has been set. If the beep notification mode flag has not been set, the method repeats from step 400. If, at step 409, it is determined that the beep notification mode flag has been set, the method advances to step 410 wherein the stopwatch timer is read. The method then advances to step 411 wherein it is determined whether the wait time has expired. If it is determined that the wait time has not expired at step 411, the process repeats from step 400. If, however, it is determined that the wait time has expired at step 411, the method advances to step 412 wherein a notification beep tone is injected into the audio path. The method then advances to step 413 wherein the stopwatch timer is reset before returning to step 400.

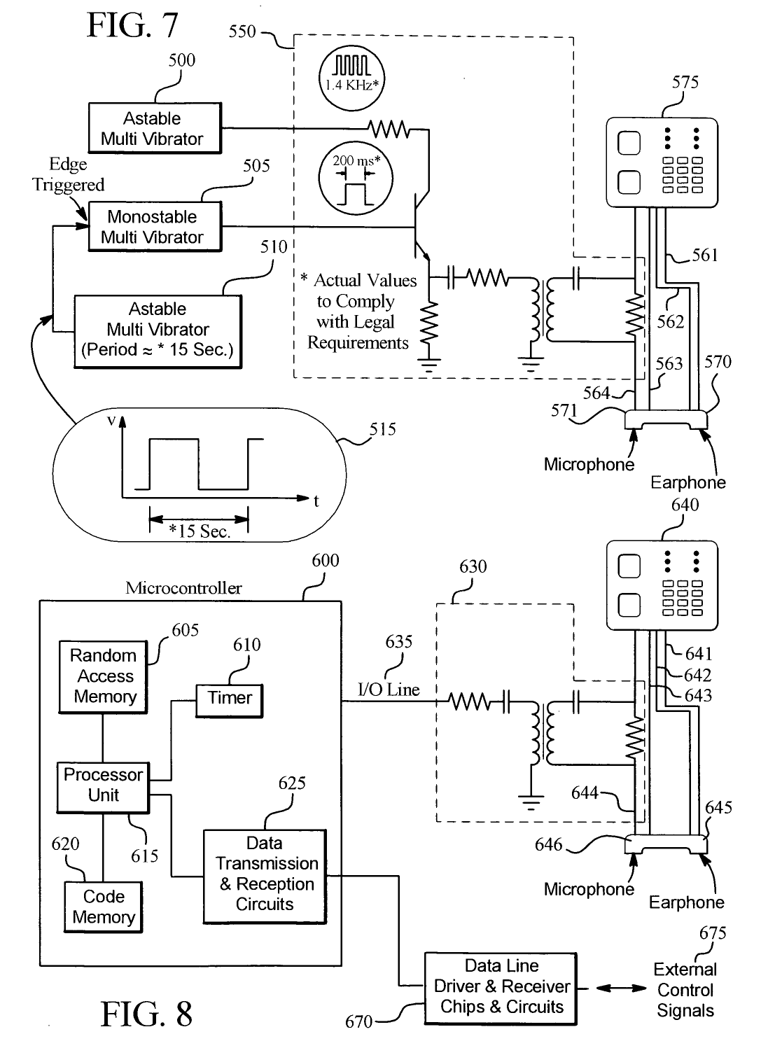

Referring now to FIG. 7, FIG. 7 illustrates an example of an electrical schematic overview of an audio notification device. The embodiment of FIG. 7 contains timer chips that utilize resistors and capacitors for timing purposes. There are several chips that perform this function including the LM555 and devices in the “74 series” family made by National Semiconductor. This embodiment provides for a system with a low overall cost, but also lacks precision and configurability. Note that this embodiment supports audio notification and that the previously described control functionality has been streamlined to “plug it in and it is on.”

Turning to the description of FIG. 7, deskset (575) is shown connected to microphone (571) and earphone (570) through connections 561 to 564. Attached to connection 564 are resistor capacitor (RC) timer circuits (500)(505)(510) for controlling the generation and injection of the audio notification into the call. The RC timer circuits are configured to provide beep notifications about every 15 seconds, controlled by adjustable multivibrators (500) and (510), and a monostable edge triggered multivibrator (505).

FIGS. 8 & 9 illustrate an example of electrical schematic overviews utilizing a microcontroller and central processing unit, respectively. Once again, utilizing ASICs, FPGAs, system-on-a-chip and other modern technologies, the distinction between hardware solutions and software solutions can be blurred.

FIG. 8 illustrates the use of a microcontroller where various functional blocks that support the processor are included in a single package. The deskset (640) is shown connected to microphone (646) and earphone (645) through connections 641 to 644. Attached to connection 644 is a series injection circuit (630) for controlling the injection of the beep notification into the call. The microcontroller (600) is connected to the circuit (630) through bidirectional a line (635). The microcontroller (600) provides the processing unit (615), code memory (620), and random access memory (RAM) (605) necessary to control the timing of the injection of the beep notification into the call. The processor unit utilizes a timer (610) to achieve this control.

Also included in the microcontroller (600) is data transmission and reception circuits (625) capable to transmit and receive signals. Such signals can be received control signals (675) being transmitted from a data line driver and receiver chips and circuits (670), or can be signals generated from the data transmission and reception circuits (625) to the data line driver and receiver chips and circuits (670).

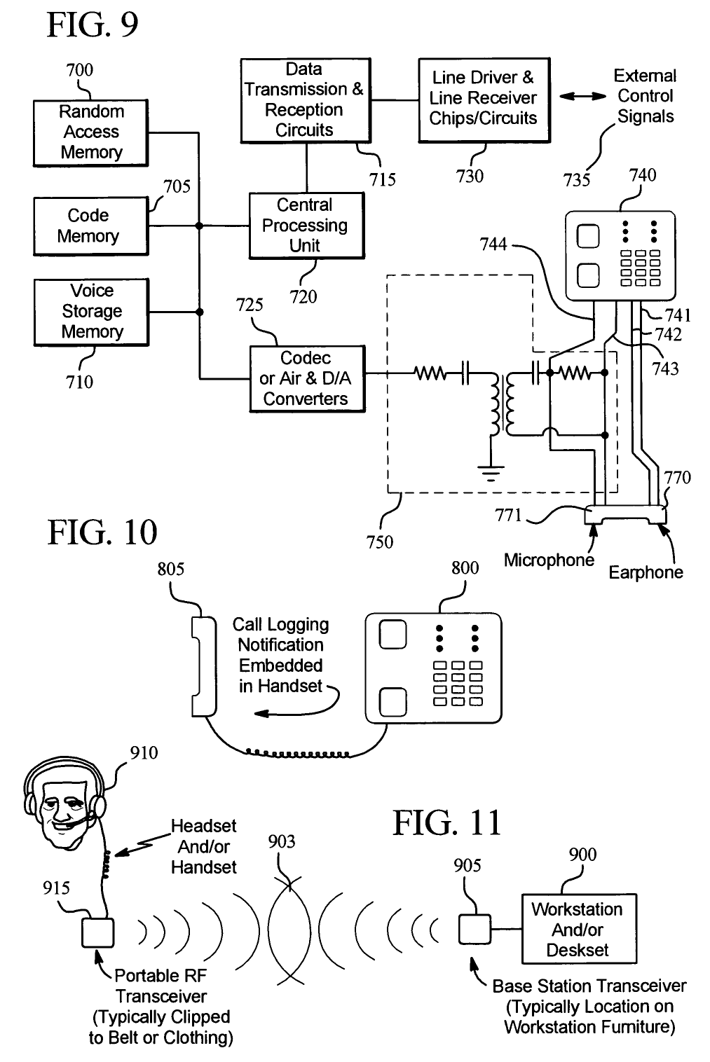

FIG. 9 illustrates the use of discrete chips for each function, similar to the functions described in FIG. 8. In FIG. 9, however, the audio notification is injected through a parallel injection scheme. In FIG. 9, the circuit (750) is connected in parallel to connections 744 and 743 between the deskset (740) and the microphone (771). The audio notification is injected into the call utilizing the above described circuit (750) and connections 744 and 743, while the generation and timing of the injection of the audio notification is controlled by a number of interconnected components.

For example, RAM (700), code memory (705) and voice storage memory (710) are connected to a codec or analog to digital and digital to analog converters (725), and a central processing unit (720). The codec (725) is responsible for converting between the digital and analog signals being passed from the circuit (750) and the different components connected thereto. The processing unit (720) provides the control functionality for determining and controlling the timing of the injection of the audio notifications. In addition, the central processing unit (720) is connected to data transmission and reception circuits (715), which are connected to line driver and line receiver chips and/or circuits (730), thereby allowing the processing unit (720) to send and receive signals, such signals including external control signals (735).

The series and parallel injection configurations shown in FIGS. 8 and 9 are two examples of how call logging notification audio can be injected. Note that the equipment configurations shown in FIGS. 8 and 9 can be used for verbal notification, beep notification or both.

Headset and/or Handset

Another embodiment of the present disclosure embeds the call logging notification functionality in the headset or handset or connectors to either. As technology advances it becomes more practical to embed functionality in equipment. In addition, as technology advances there are many signal paths that previously were analog-only that now could optionally be analog-only, digital-only or a combination of analog and digital.

FIG. 10 illustrates an embodiment of the present disclosure where call logging notification functionality is embedded in a handset (805). For example, in FIG. 10, the call logging notification tone generator is embedded inside an analog handset (805) for use with workstations (800) where all calls are to be recorded. In an alternative embodiment, a handset (805) with digital signals in the cord connecting it to the deskset/workstation (800) can be utilized to achieve the desired result. In addition, the handset (805) may provide verbal logging notification functionality, and may also include logging notification control signals in the cord connecting the handset/headset (805) to the deskset and/or workstation (800), wherein the logging notification control signals are capable to select and/or disable verbal or visual notification, select and/or disable beep notification, alter volume and/or mute notification audio to the customer, alter volume and/or mute notification audio to the operator, initiate notification audio, or provide for other functions. Alternatively, the handset (805) can display visual notification to the call handler, if so desired.

FIG. 11 illustrates an example where the call logging notification functionality is embedded in a headset (910). The headset (910) with the embedded call logging notification is connected to a portable transceiver (915), which communicates with a base station transceiver (905) through a link (903). The base station (905) is connected to the workstation or deskset (900). Therefore, the call logging notification is injected into the call at the headset and communicated to the workstation through the link (903).

In one embodiment the call logging notification tones are generated and inserted into the operator's microphone path on a continuous basis. This embodiment is appropriate if all calls at the facility may be logged and if tones are a legally acceptable method of call logging notification.

The RF link (903) shown in FIG. 11 does not indicate the type of link being used. The Bluetooth standard is commonly used by headset manufacturers, however, the example is independent of the RF standards and specifications, and therefore, is not specifically tied to the use of Bluetooth.

Note that the RF link (903) needs to be bidirectional to support both operator to customer conversation, and customer to operator conversation. In the example of FIG. 11, the embodiment is independent of the analog or digital method in which the audio is transported over the RF link (903). Furthermore, FIG. 11 is independent of the presence or absence of additional control paths (analog or digital) in the RF link (903). It is important to note, however, that the presence of additional control paths provides the opportunity to enable and/or disable verbal notification, enable and/or disable beep notification, enable and/or disable visual notification, initiate verbal notification, adjust volumes of operator to customer or customer to operator audio paths, mute audio paths, and/or control the call logging functionality in other ways.

RF Link Base Station

Traditionally headsets and/or handsets used for telephone communication are connected to desksets and/or workstations by wires. In many cases these wires are in the form of a “coil cord” such as is commonly found on telephones in homes and businesses. With advances in technology there are now headsets and/or handsets that utilize a wireless or radio frequency (RF) link between the headset/handset and the deskset/workstation. These wireless links include, but are not limited to, RF links and links using the “Bluetooth™” standard that is now utilized in headsets and other commercially available devices that are commonly connected to personal computers.

A RF link headset, utilizing any RF standard, may have all of its circuitry contained in the portion of the headset that is worn on the head of the user (over the head, over the ear, or other), or some of the circuitry and/or batteries may be in an additional enclosure that typically is held by a clip to the belt or clothing of the operator. For descriptive purposes, the overall composite collection of equipment worn by the operator is considered to be the RF link headset regardless of whether one or more enclosures is utilized for the earphone element, microphone element, battery(s), audio circuitry, RF circuitry, and any switches or indicators that may or may not be present.

A RF link basestation, utilizing any RF standard, may have all of its circuitry and/or antenna(s) located in one or more enclosures. Again, for descriptive purposes of describing this embodiment the RF link basestation can be considered to be the RF link equipment that is not worn by the operator. Typically this will consist of one or more enclosures located near the deskset and/or workstation, or in the deskset itself. This basestation might sometimes be referred to as a receiver since it is easy to simplify the equipment functionality as stating that the RF link transports the audio from the microphone of the portable headset to the microphone wires of the stationary equipment. But, in reality the RF link equipment must transport audio in both directions to support the customer microphone to operator earphone path too. Thus, both the headset portion of the RF link and the basestation portion of the RF link are transceivers.

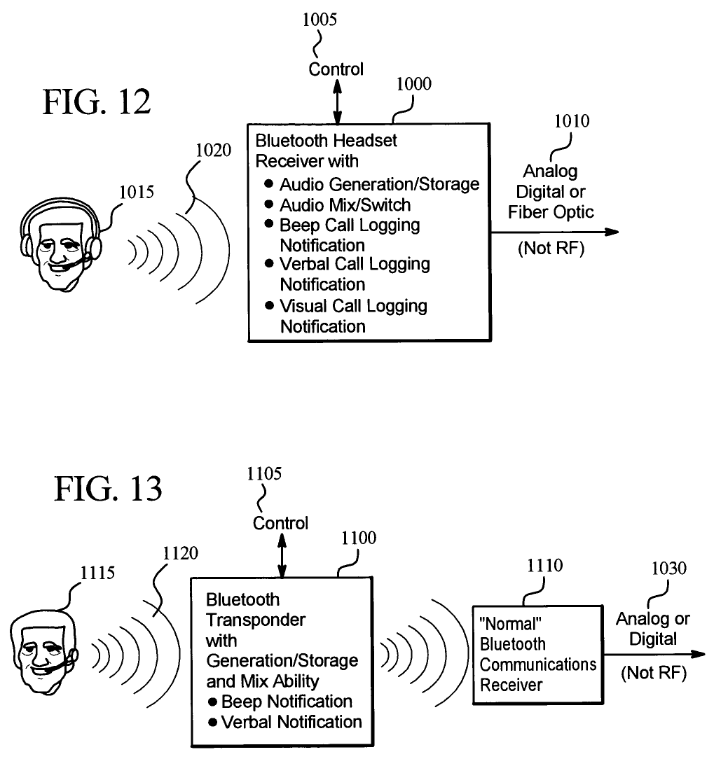

Referring to FIG. 12, FIG. 12 illustrates an example of an embodiment where the call logging notification functionality is included in the basestation of an RF link. In FIG. 12, conversation is communicated from the headset (1015) through a link (1020) to a Bluetooth enabled base station receiver (1000). The receiver (1000) can then be connected to a workstation or deskset (not shown) through an appropriate means (1010). The receiver (1000) is configured to inject call logging notification into the conversation, and is further capable of generating and storing audio, mixing and switching audio, providing beep call logging notification, providing verbal call logging notification, and providing visual call logging notification. The receiver (1000) is also configured to transmit and receive control signals (1005) for interaction with other devices.

RF Link Transponder

The use of RF links has previously been described herein. These RF links are typically utilized in a “from this point to that point” fashion where “one point” is the headset and “the other point” is the workstation and/or deskset. Even if the RF link were multiplexed in some fashion, enabling multiple devices to utilize the same RF frequency, the RF link is still utilized to connect headset A to deskset/workstation A, headset B to'deskset/workstation B, etc.

A transponder is a radio transmitter and receiver combination where the transmissions are initiated in response to signals being received by the receiver. A simple example of a transponder is where two people in valleys are not able to communicate with each other due to a mountain that is located between them. If both people establish radio communication with a transponder located on the top of the mountain, then a radio relay, known as the transponder, relays signals back and forth between the two valleys in order to enable the two people to communicate with each other.

A more complicated transponder can transmit a reply signal rather than simply relaying the signal that it has received. An example of such includes a transponder aboard an aircraft. An air traffic controller might instruct a pilot to “squawk 1234.” In response to this request the pilot would configure his/her transponder to utilize the “1234” code. After being properly configured, the aircraft transponder would wait to be interrogated by radio transmissions from the air traffic control center. After receiving an interrogation signal the transponder responds by transmitting a signal comprising the “1234 squawk code” and possibly other information. In this case, the transponder transmits in response to receiving a signal, but the transmission is not relaying a copy of the received signal.

Referring to FIG. 13, FIG. 13 illustrates an example of a RF transponder (1100) that communicates with both the headset (1115) and the deskset and/or workstation (not shown). As described above, there would actually be two transponders present to support “transponding” in both the operator to customer direction and the customer to operator direction. For simplicity of describing the example, only the operator to customer path is shown. Also note that the shown Bluetooth enabled transponder (1100) is just an example, as the transponder can be of any appropriate type.

The transponder (1100) shown in FIG. 13 would relay audio and possibly other data or control information (1105) through it. In addition, whenever appropriate, the transponder mixes additional audio into the existing audio stream. This mix can be done in an analog or digital fashion depending upon implementation decisions made at equipment design time. The audio mixed in can be call logging notification tones, call logging notification verbal announcements and/or other tones or announcements utilizing a generic or personalized voice.

FIG. 13 illustrates the conversation being communicated from the headset (1115) through a link (1120) to a Bluetooth transponder (1100). The transponder (1100) is configured to inject call logging notification into the conversation, and, in this embodiment, is further capable of generating and storing audio, mixing and switching audio, and providing beep call logging notification and/or verbal call logging notification. In this embodiment, the transponder (1100) is also configured to transmit and receive control signals (1105) for interaction with other devices. The transponder communicates with a Bluetooth communications receiver (1110), which can then be connected to a workstation or deskset (not shown) through an appropriate connection means (1130).

Telephone Deskset

There exist in the telecommunications market telephone desksets with embedded call recording capabilities. However desksets with embedded call logging notification capabilities, but without associated recording capabilities, do not exist. Typically, call centers prefer to have centralized call logging systems, but this logging equipment often can not provide the appropriate notification. Thus, incorporating call logging notification into the telephone deskset provides a unique way to comply with legal notification requirements without increasing the workstation clutter.

Furthermore, corded and cordless telephones exist in today's marketplace that have the integrated ability to internally generate beep tones and other warning signals typically to the phone's user to indicate various conditions regarding the operation of the telephone itself. These conditions may include activation of the mute feature, or a low battery situation. The present disclosure includes implementing circuitry, software, and/or firmware to make these tones audible to one or more parties to provide call logging notification. The present disclosure also includes enhancing the phone to support the capability and/or selection whereby the call handler can choose to be notified via visual notification while the other parties may receive either audio or visual notifications.

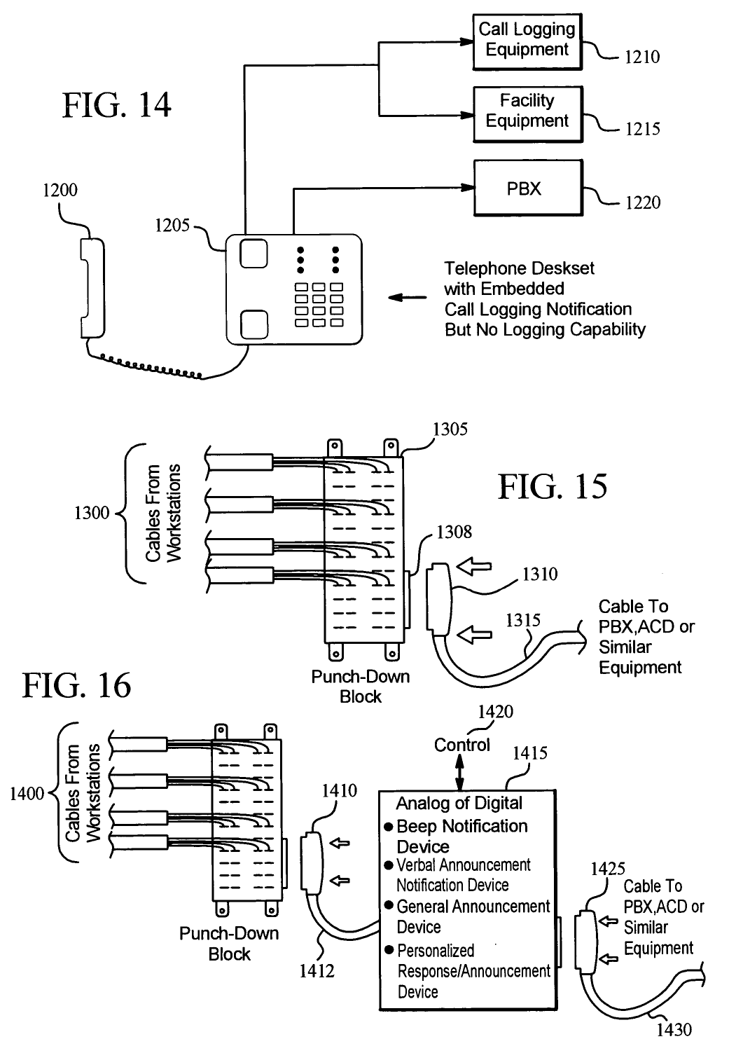

FIG. 14 illustrates an example of a telephone deskset (1205) with embedded call logging notification in accordance with the present disclosure. The deskset (1205) is connected to a handset or headset (1200) for communication of the conversation. In this example, the deskset includes call logging notification functionality as described herein, but does not contain call logging capability. Therefore, the deskset (1205) is connected to call logging equipment (1210) in order to provide such capability. In addition to the call logging equipment, the deskset (1205) is connected to facility equipment (1215) and a PBX (1220) for transmitting and receiving control signals, and distributing calls, respectively. Alternatively, the call logging notification functionality can be included in a device with call logging capabilities.

Equipment at Punch-Down Block

There may be a desire or requirement at a facility that call logging notification functionality be added without installing equipment at the individual workstations or telephones. In many telecommunications facilities the cables at each workstation or telephone run back to a common termination area. Often an item known as a “punch down block” will be the connector device that serves as the termination for each one of the workstation/telephone's individual cables. The exact details of a punch down block may vary from model to model but in all of them some sort of a connector is present for making a connection to the individual wires of each workstation/telephone's cable. An example of such is the M4-4W-TP manufactured by Siemon.

A common form of the block utilizes metal blades with a gap between them. A special tool is used to push the wire down (punch down) between the metal blades. The metal blades are close enough together to cut through the wire's insulation, but far apart enough to avoid cutting the metal conductor in the wire. The metal blade, being in contact with the metal conductor of the wire, forms a secure electrical connection with the wire. In this type of punch-down-block it is common for each of the numerous metal blades to be electrically connected to a contact of a multiple conductor connector that is mounted to the punch-down-block.

Thus, the punch-down-block serves to physically terminate each individual cable that is run to the various workstations and/or telephones in a facility. Furthermore, the punch-down-block consolidates the (potentially) many conductors from the (potentially) many cables down to many conductors in a single connector. Multiple conductor cables with appropriate connectors can then be plugged into the punch-down block's connector allowing PBXs, ACDs or other equipment to easily be connected to the various workstations and/or telephones.

Referring to FIG. 15, punch-down block (1305) is shown connected at connector 1308 to connector 1310 which provides a connection (1315) to a PBX, ACD or other facility equipment. The punch-down-block connection technique described above can be repeated such that a single physical punch-down-block may have more than one multiple conductor connector mounted to it. In addition, it is common for facilities to further repeat the process by utilizing more than one punch-down-block.

Referring to FIG. 16, FIG. 16 illustrates an example where multiple conductor connectors at the punch-down-block present an opportunity to connect many or all of the workstations and/or telephones without the need to physically install new equipment at the workstation and/or telephone. The connections from the individual workstations (1400) and/or telephones to the PBX or other equipment remain intact, but physically these connections pass through a call logging notification device (1415). This device (1415) has the ability to mix, inject and/or modify the signals in whatever facility equipment dependent manner is appropriate. This signal alteration is done to provide verbal and/or tone call logging notification.

Note that in FIG. 16 a control line (1420) is illustrated. This control line (1420) may be absent, present as a single direction control, or present as bidirectional control. The control functionality may consist of external equipment notifying the call logging notification functionality to enable and/or disable tone notification, enable and/or disable verbal notification, enable and/or disable visual notification, initiate verbal notification, adjust volumes, mute audio paths or to take other control actions. For these control activities the control may be single directional or bidirectional depending upon implementation.

There also may be present in the call logging notification equipment the ability to detect the presence of audio energy, the ability to detect the presence of voice, speech recognition capabilities, or other capabilities that make it possible for the call logging notification functionality to detect a customer's presence on the line, and therefore, detect that it is appropriate to initiate the call logging notification. This ability to detect the presence of the customer on the line is of value to equipment other than the call logging notification equipment. Thus, another use for the control path (1420) would be to provide other equipment, for example the call logger, with the information that the customer is on the line. This requires flow of control information out from the call logging notification device (1415).

Workstation Software

There will typically be, at a minimum, several types of software installed on a computerized telecommunications workstation. There will be the operating system of which Windows® and Linux are common examples. There will also be device drivers, application software and quite possibly other software items.

The operating system is the software that controls the execution of computer programs and may provide various services. The device drivers provide the capability for the somewhat generic operating system to communicate with and control specific hardware options such as network interface cards (NIC) or chips, audio or video interface cards or motherboard mounted chips, and other peripheral devices.

Application software is the term for what most computer users would consider to be “the program” that they use. Examples of application programs are word processing programs, spreadsheets and games. The “soft phone” and other call handling software that the operator uses are also examples of application software.

There exist techniques that software engineers can use to place a software item in the middle of the flow of data between the application software and the operating system or between the application software and the device drivers. These techniques are commonly used by people referred to as “hackers” as they “infect” other peoples computers and steal data and/or control other people's computers. These techniques may also be used for good purposes, such as the call logging notification functionality disclosed herein. Adding desired functionality to a computer workstation is an example of a good purpose for these techniques. At times a specific application software item may not provide all desired functionality. At other times a desired functional capability may be implemented incorrectly or it may be available at an additional cost that a facility may consider prohibitive. Utilization of some of the same techniques as “hackers” allows software engineers to “get in the middle of the data flow” and add functionality to an application program.

The ability to “get in the middle of the data flow” makes it possible to effectively add functionality to an application program without actually modifying the application program. For example, workstation application programs sold by company A may provide call status information to other application programs installed on the workstation but the company A software may not provide call logging notification. Company B can utilize the call status information from company A's software, “get in the middle of the data flow” between company A's software and the previously described audio circuit device drivers, and inject call logging notification audio using a workstation software item. Thus, it will appear that the software from company A injected the audio when the software from company B is actually responsible for injecting the call logging notification audio.

PBX Conferencing

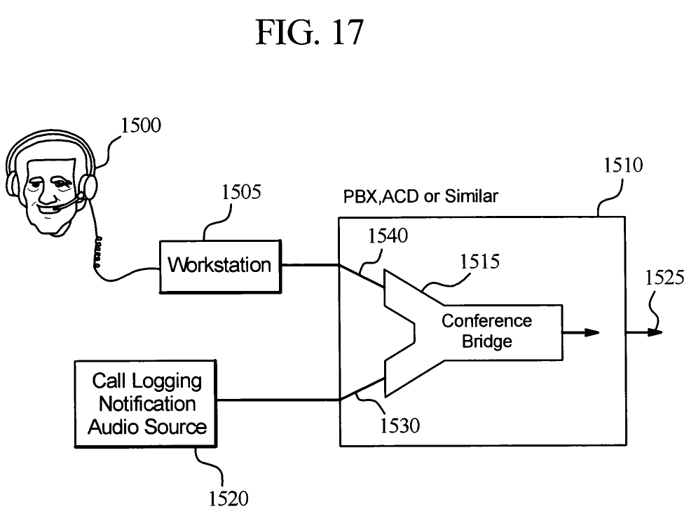

In another embodiment of the present disclosure, call logging notification audio may be injected into the communication between the operator and the customer by utilizing the conferencing capabilities of the PBX, ACD or other similar equipment. For example, referring to FIG. 17, a call logging notification audio source (1520) is shown connected to a conference bridge or port (1515) of a PBX, ACD or similar device (1510) through connection 1530. In addition, a headset (1500) connected to a workstation (1505) is also connected to the conference bridge (1515) through connection 1540. The conference bridge (1515) allows for the data on both connection paths 1530 and 1540 to be communicated as a single outgoing signal (1525) containing both the conversation over path 1540 and the call logging notification over path 1530.

Visual Notification

Referring to FIG. 18, FIG. 18 illustrates a telephone deskset (1802) in accordance with the present disclosure including a light (1804) which is illuminated to indicate that the call may be recorded. In an embodiment, the light (1804) is either always flashing, always illuminated or flashing, or illuminated whenever the phone is off hook. In another embodiment, the light (1804) is activated by messages from the call logging system, or the light (1804) is under system control. The embodiments will function equivalently regardless of the presence of a handset (1801) or a similarly functioning headset (20) as shown in FIG. 2. The light is either incandescent, florescent, CCFL, LED, or other type of illumination device.

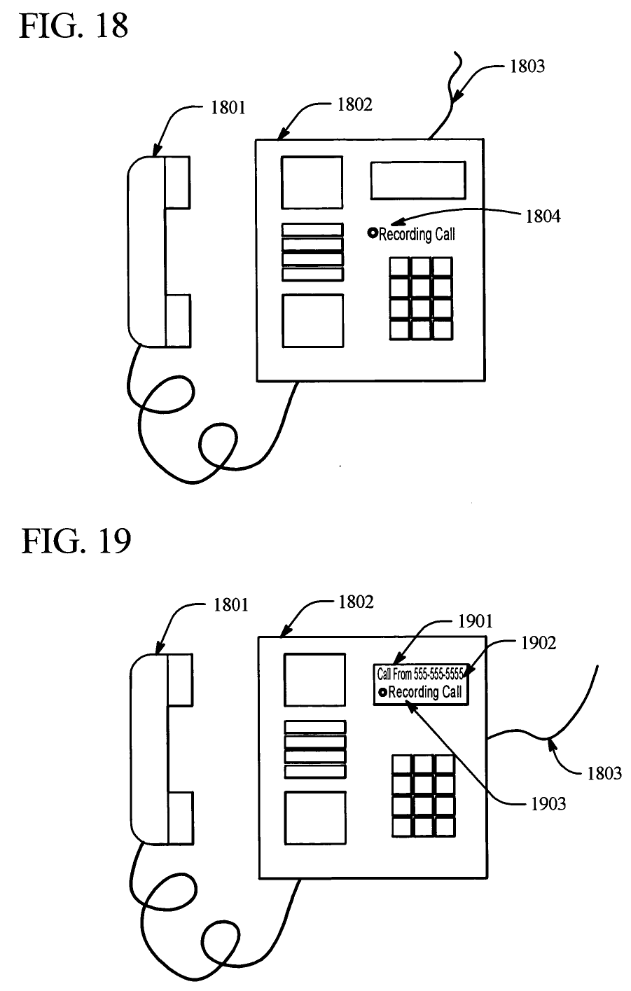

Referring to FIG. 19, FIG. 19 illustrates a telephone deskset (1802) in accordance with the present disclosure including a text display (1901) which can display call related data which includes the time of day, the day of week, the calling or called party's name, telephone number (1902), account number, call logging notification (1903) and/or other information. The embodiments will function equivalently regardless of the presence of a handset (1801) or a similarly functioning headset (20) as shown in FIG. 2. The text display (1901) is LCD, OLED, Vacuum Florescent Display, CRT or any other type of text display device.

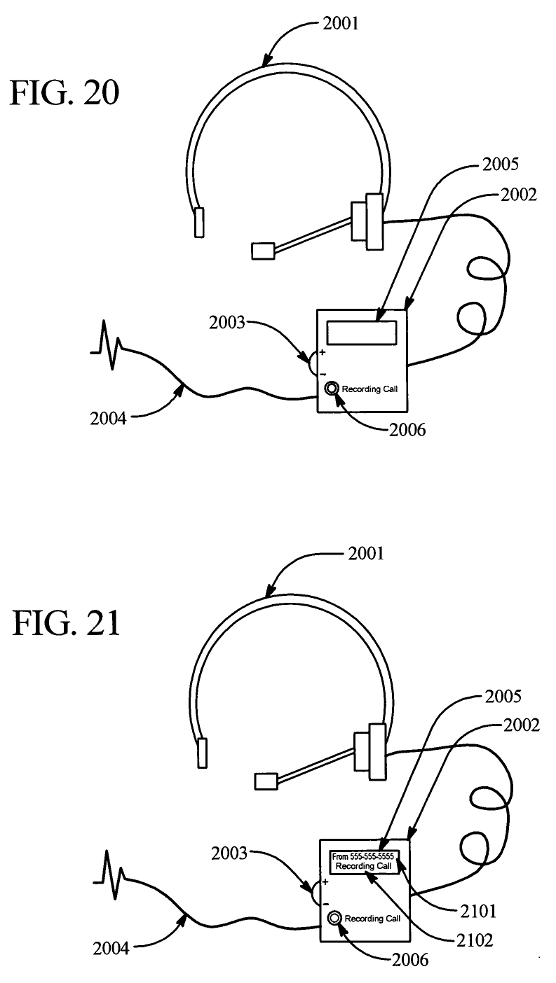

Referring to FIG. 20, FIG. 20 illustrates a telephone amplifier (2002) in accordance with the present disclosure including a light (2006) which is illuminated to indicate that the call may be recorded. In an embodiment, the light (2006) is either always flashing, always illuminated or flashing, or illuminated when the phone is off hook. In another embodiment, the light (2006) is activated by messages from the call logging system, or the light (2006) is under system control. The embodiments will function equivalently regardless of the presence of a headset (2001) or a similarly functioning handset (1801) as shown in FIGS. 18 and 19. The light (2006) is either incandescent, florescent, CCFL, LED, or other type of illumination device. The volume is controlled with a dial (2003). The amplifier (2002) is cordlessly connected to the telephone, or connected by a cord (2004).

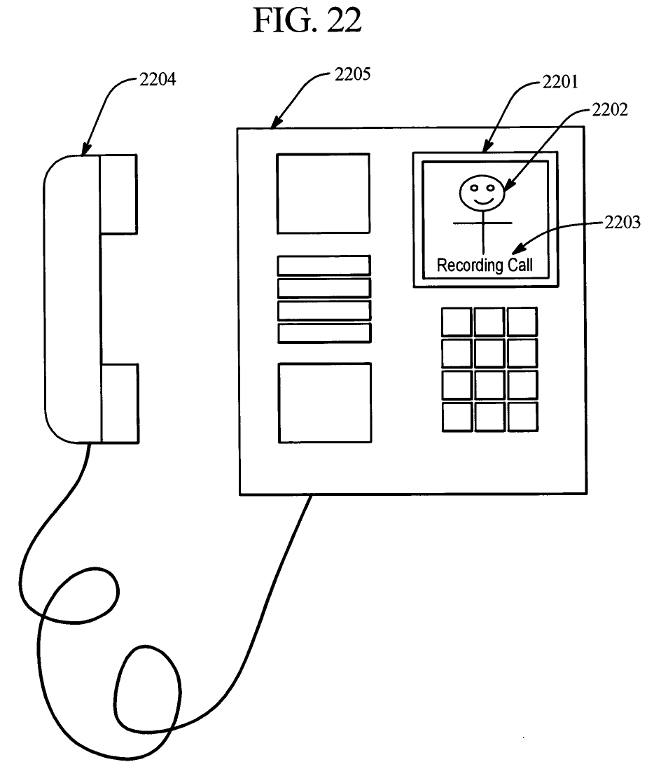

Referring to FIG. 21, FIG. 21 illustrates a telephone amplifier (2002) in accordance with the present disclosure, including a text display (2005) which can display call related data which includes the time of day, the day of week, the calling or called party's name, telephone number (2101), account number, call logging notification (2102) and/or other information. The embodiments will function equivalently regardless of the presence of a handset (1801) as shown in FIGS. 18 and 19 or a similarly functioning headset (2001) as shown in FIG. 20. The text display (2005) is LCD, OLED, Vacuum Florescent Display, CRT or any other type of text display device.

Referring to FIG. 22, FIG. 22 illustrates a telephone with an associated display (2201) in accordance with the present disclosure, including the capability to produce visual and/or video images (2202). A phone of this nature is referred to as a video phone (2205). An example of such includes the Aiptek 2000T Video Phone. Video phones are compatible with other videophones such that both parties can see visual or video images (2202) of each other while speaking on the phone. However, these phones are also compatible with traditional audio-only phones whereby the video phone operates in an audio only mode.

In all embodiments, the video display of the video phone is used to display the call logging notification (2203). Additionally, the video display (2201) can display call related data which includes the time of day, the day of week, the calling or called party's name, telephone number, account number and/or other information. The embodiments will function equivalently regardless of the presence of a handset (2204), or a similarly functioning headset or hands-free speakerphone system. The video text display (2201) is LCD, OLED, Vacuum Florescent Display, CRT, plasma, projection or any other type of video display device.

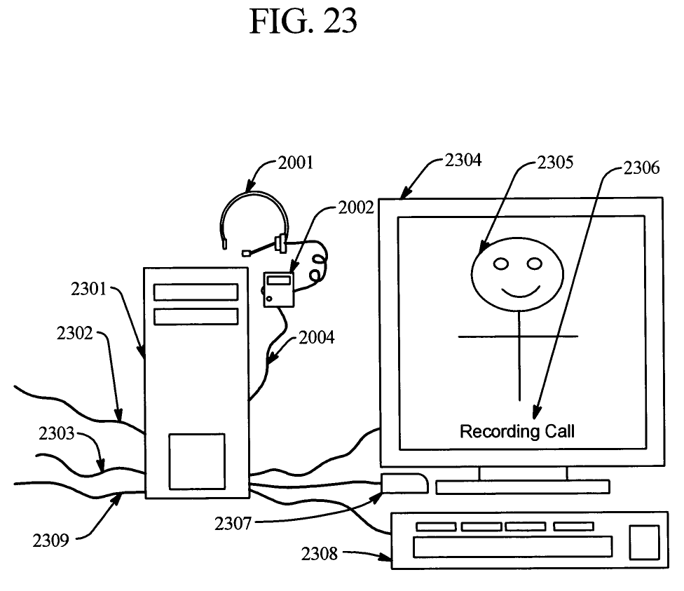

Referring to FIG. 23, FIG. 23 illustrates a computer telephony system with visual call logging notification. The computer (2301) performs data processing functions which include the facilitation of telephonic communication and other related and/or unrelated tasks. The system consists of a computer (2301), a display device (2304), and a two way audio communication device illustrated as a headset (2001). The system uses the computer (2301) to pass-through and/or process the audio and/or video data, and information required to facilitate communication. The computer (2301) sends and receives data over a wired (2309) or wireless connection with the Internet, network, communications server, PBX or other hosts and/or connections. The communication method is analog, digital, voice over internet protocol, or other method. The user communicates verbally via a corded (2004) or cordless headset (2001), a handset, a hands-free microphone/speakerphone, or other two-way audio configuration.

In all embodiments, the video display of the computer telephony system is used to display the call logging notification (2306) shown as text but also includes icon representations and/or other visual notification methods. Additionally, the video display (2304) can display call related data which includes the time of day, the day of week, the calling or called party's name, telephone number, account number and/or other information. The embodiments will function equivalently regardless of the presence of a handset, similarly functioning headset, or hands-free speakerphone system. The video display (2304) is LCD, OLED, Vacuum Florescent Display, CRT, plasma, projection or any other type of video display device.

The system requires a power cord (2302), and a corded or cordless network or telephone connection (2303). It must be noted the function of these cables can be combined such that there is a reduction in the number of cables and connections. The computer telephony embodiment illustration also includes speakers (2307) and a computer keyboard (2308). In an embodiment, bidirectional control signals can be used to remotely initiate, for example, visual notification on the display (2304), and to provide a signal from the computer to external devices as to whether the visual notification is functioning properly.

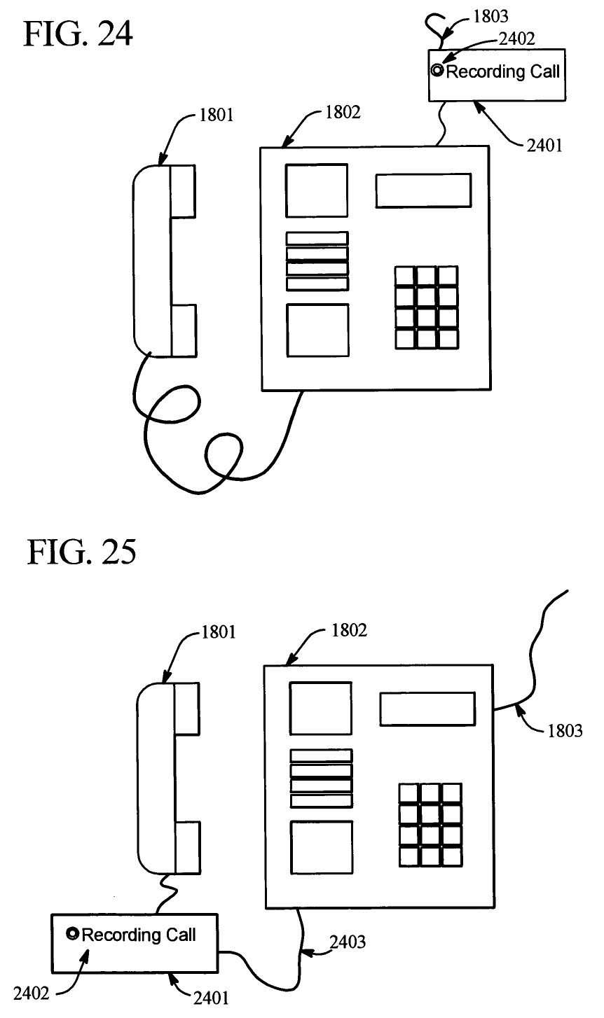

Referring to FIG. 24, FIG. 24 illustrates a visual call logging notification device (2401) which includes a light (2402) which is illuminated to indicate that the call may be recorded. In an embodiment, the light (2402) is either always flashing, always illuminated or flashing or illuminated whenever the phone is off hook. In another embodiment, the light (2402) is activated by messages from the call logging system, or the light (2402) is under system control. The device is located in line between the telephone (1802) and the wall plug, and is connected to the telephone cord (1803). In an embodiment where telephone system can generate the call logging notification to the customer, the device (2401) provides the legal notification to the call handler. In an embodiment were the telephone system cannot generate the call logging notification to the customer, the device (2401) provides the audio notification to the customer and provides visual notification to the call handler. In an embodiment, bidirectional control signals can be used to remotely initiate, for example, visual notification on the light (2402), and to provide a signal from the device (2401) to external devices as to whether the light (2402) is functioning properly.

Referring to FIG. 25, FIG. 25 illustrates a visual call logging notification device (2401) in accordance with the present disclosure including a light (2402) which is illuminated to indicate that the call may be recorded. In an embodiment, the light (2402) is either always flashing, always illuminated or flashing, or illuminated whenever the phone is off hook. In another embodiment, the light (2402) is activated by messages from the call logging system, or the light (2402) is under system control. The device is located in line between the telephone (1802) and the handset (1801), and is connected to the handset cord (2403). In an embodiment where telephone system can generate the call logging notification to the customer, the device (2401) provides the legal notification to the call handler. In an embodiment were the telephone system cannot generate the call logging notification to the customer, the device (2401) provides the audio notification to the customer and provides visual notification to the call handler. In an embodiment, bidirectional control signals can be used to remotely initiate, for example, visual notification on the light (2402), and to provide a signal from the device (2401) to external devices as to whether the light (2402) is functioning properly.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A call logging notification system for providing call logging notification to one or more parties to a telephone or videophone conversation, the system comprising:
means for receiving control signals, wherein the control signals indicate, among other information, information associated with the conversation; and
a call logging notification means for providing call logging notification in response to the control signals.

2. The system as described in claim 1, wherein the call logging notification means selectively allows call logging notification to some or all of the parties to the conversation.

3. The system as described in claim 1, wherein the call logging notification means is installed to restrict the ability of a call handler to disconnect or bypass the call logging notification.

4. The system as described in claim 1, wherein the call logging notification means is operable to provide at least one audible notification to the parties to the conversation and to a call handler.

5. The system as described in claim 4, wherein the call logging notification means includes at least one system control operable to reduce or eliminate the volume of the audible signal provided to the call handler.

6. The system as described in claim 1, wherein the call logging notification means is operable to provide at least one audible notification to the parties to the conversation and a different notification to a call handler.

7. The system as described in claim 6, wherein the different notification provided to the call handler is selected from the group consisting of: an audible notification; a verbal notification; a visual notification; or an audiovisual notification.

8. A call logging notification apparatus for providing call logging notification to one or more parties to a telephone or videophone conversation, the apparatus comprising:
a housing;
an amplifier within the housing for amplifying communication signals associated with the conversation; and
a call logging notification generator within the housing for injecting call logging notification signals into the communication signals.

9. The call logging notification apparatus as described in claim 8, wherein call logging notification generator selectively provides call logging notification to some or all of the parties to the conversation.

10. The call logging notification apparatus as described in claim 9, wherein the call logging notification generator selectively provides audible call logging notification to at least one party to a conversation while providing visual call logging notification to at least one additional party to the conversation.

11. A method for providing call logging notification to a telephone or videophone communication between two or more parties, the method comprising:
determining when a communication is activated between the two parties;
selectively injecting an indicator into the communication in response to the determination that the communication is activated to indicate call logging of the active communication;
determining when the communication between the two parties has ended; and
terminating the injection of the indicator in response to the determination that the communication has ended.

11. The method of claim 10, wherein the call logging indication is selectively provided to some or all of the parties.

12. A call logging notification system for providing call logging notification to one or more parties to a telephone or videophone conversation, the system comprising:
a call logging notification means for providing call logging notification.

13. The call logging notification system as described in claim 12, wherein the call logging notification means selectively allows the call logging notification to be provided to some or all of the parties to the conversation.

14. The call logging notification system as described in claim 12, wherein the call logging notification means restricts the ability of a call handler to disconnect or bypass the call logging notification.

15. The call logging notification apparatus as described in claim 12, wherein the call logging notification means is operable to provide at least one audible notification to the parties to the conversation and to a call handler.

16. The call logging notification apparatus as described in claim 15, wherein the call logging notification means includes at least one system control operable to reduce or eliminate the volume of the audible signal provided to the call handler.

17. The call logging notification apparatus as described in claim 16, wherein the call logging notification means is operable to augment or substitute visual notification when the volume of the audible signal provided to the call handler has been reduced or eliminated.

18. A call logging notification apparatus for providing call logging notification to one or more parties to a telephone or videophone conversation, the apparatus comprising:
a housing; and
a visual call logging notification indicator within the housing wherein the apparatus is configured to indicate call logging notification to at least one party to the conversation.

19. A call logging notification system for providing call logging notification to one or more parties to a telephone or videophone conversation, the system comprising:
a call logging notification means for providing audible call logging notification to at least one party to a conversation while providing visual call logging notification to at least one additional party to the conversation.

20. A method for providing call logging notification to a telephone or videophone conversation between two or more parties, the method comprising:
injecting an indicator into the communication so that call logging indication is provided to at least one of the parties, regardless of whether call logging is actually performed.
